(19) United States
(12) Patent Application Publication
(10) Pub. No.: US 2014/0105664 A1
(43) Pub. Date: Apr. 17, 2014

(54) Keyboard Modification to Increase Typing Speed by Gesturing Next Character

(71) Applicant: INTERNATIONAL BUSINESS MACHINES CORPORATION, Armonk, NY (US)

(72) Inventor: Carlos A. Hoyos, New York, NY (US)

(73) Assignee: INTERNATIONAL BUSINESS MACHINES CORPORATION, Armonk, NY (US)

(21) Appl. No.: 13/671,761

(22) Filed: Nov. 8, 2012

Related U.S. Application Data
(63) Continuation of application No. 13/654,050, filed on Oct. 17, 2012.

(51) Int. Cl. B41J 5/12

(52) U.S. Cl. 400/472

(57) ABSTRACT

An embodiment of the invention provides a method of character recognition wherein user input is received with a sensor. The user input includes movement on a first axis and movement on a second axis. The receiving of the user input also includes determining the amount of pressure of the movement on the second axis of the key, and/or the duration of the movement on the second axis of the key. A processor matches the movement on the first axis of the key with a first character and the movement on the second axis of the key with a second character. The first character followed by the second character are displayed when the amount of pressure of the movement on the second axis of the key is above a threshold pressure and/or the duration of the movement on the second axis of the key is above a threshold duration.

This patent application is a continuation application of U.S. patent application Ser. No. 13/654,050 filed on Oct. 17, 2012, which is hereby incorporated by reference.

### BACKGROUND

The present invention is in the field of methods, systems, devices, and computer program products for keyboard modification to increase typing speed by gesturing next character.

With the advent of smaller, more powerful microprocessors, small form devices such as cellular telephones and tablet computers are used every day for complex tasks that often require a full keyboard to interact with. This has resulted in the miniaturization of both physical keyboards (e.g., smart phones) and virtual keyboards (e.g., touchscreen interfaces). The smaller keyboards are typically accessed with only one finger on each hand (e.g., thumb or index).

### SUMMARY OF THE INVENTION

An embodiment of the invention provides a method of character recognition wherein user input is received with a sensor proximate to a key. The user input includes movement on a first axis of the key and movement on a second axis of the key. The receiving of the user input also includes determining the amount of pressure of the movement on the second axis of the key, and/or the duration of the movement on the second axis of the key. A processor matches the movement on the first axis of the key with a first character. The processor also matches the movement on the second axis of the key with a second character when the amount of pressure of the movement on the second axis of the key is above a threshold pressure and/or the duration of the movement on the second axis of the key is above a threshold duration. The first character followed by the second character are displayed on a display when the amount of pressure of the movement on the second axis of the key is above the threshold pressure and/or the duration of the movement on the second axis of the key is above the threshold duration.

Another embodiment of the invention receives user input with a touchscreen keyboard, wherein the user input includes contact with a key on the touchscreen keyboard and movement on the key in a select direction. A processor matches the contact with the key with a first character. The processor also matches the movement on the key in the select direction with a second character. The first character followed by the second character is displayed on a display.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a portion of a keyboard and a key according to an embodiment of the invention;

FIG. 2 illustrates a sensor positioned under a key of a physical keyboard according to an embodiment of the invention;

FIG. 3 is a flow diagram illustrating a method of character recognition according to an embodiment of the invention;

FIG. 4 is a flow diagram illustrating a method of character recognition according to another embodiment of the invention;

FIG. 5 is a flow diagram illustrating a method of character recognition according to yet another embodiment of the invention;

FIG. 6 illustrates a character input device according to an embodiment of the invention;

FIG. 7 illustrates a character input device according to another embodiment of the invention; and

FIG. 8 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

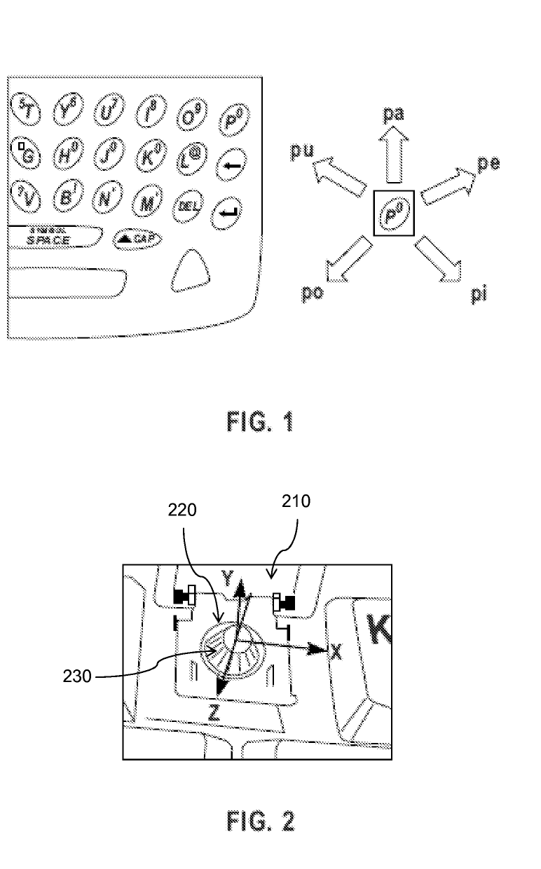

At least one embodiment of the invention facilitates the input of two characters with one key press. This takes advantage of how well suited thumbs are to press and tilt in one movement. In at least one embodiment, each consonant on the keyboard is combined with one or more vowels, wherein the vowel is selected by tilting a key as the key is pressed. FIG. 1 illustrates a portion of a QWERTY keyboard on a smart phone and a focused illustration of the “P” key of the QWERTY keyboard according to an embodiment of the invention. The “P” key is pressed and it can be and subsequently (or simultaneously) tilted in one of five directions to select the character “P” and a second character, e.g., “PA”, “PE”, “PI”, “PO”, or “PU”. Although the embodiment illustrated in FIG. 1 shows that the first character is a consonant and the second character is a vowel, it is recognized that either the first or second character can be a consonant, vowel, number, or symbol. In at least one embodiment, the different choices for second characters and their corresponding tilt directions are displayed to the user of the keyboard, e.g., on a monitor or a touchscreen display.

The process of character entry does not require the memorization of a new keyboard. Moreover, the process is backward compatible and does not change the typing rhythm. In other words, the total number of keys on the keyboard does not have to be reduced when compared to the number of keys on a standard keyboard. For instance, in the example illustrated in FIG. 1, the “U”, “A”, “E”, “I”, and “O”, keys do not have to be removed from the keyboard

The process reduces the number of key taps. For example, to enter the word “PATENT”, 6 key taps are needed on a conventional keyboard. In the methods and devices described herein, only 4 key taps can be used to enter the word “patent”, i.e., the “P”, “T”, “N”, and “T” consonant keys. In another embodiment, only 3 key taps are used to enter the word “PATENT”, i.e., pressure on the “P” key along 2 axes, pressure on the “T” key along 2 axes, pressure on the “N” key along 2 axes. In yet another embodiment, only 1 key tap is used to enter the word “PATENT”, i.e., pressure on the “P” key in a downward direction followed by pressure along five other axes on the “P” key.

The process of character entry can be implemented on both a physical keyboard (e.g., smart phone) as well as a virtual keyboard (touchscreen). In at least one embodiment of the invention, a physical keyboard includes sensors to capture pressure changes in the X-Y plane. FIG. 2 illustrates a sensor positioned under the “J” key of a physical keyboard according to an embodiment of the invention. Each time a key is pressed, the keyboard can detect a change in the Y axis of the key (e.g., up and down axis). One or more sensors also detect a change in the X and/or Z axes of the key. In at least one embodiment, sensors are installed for each key. In another embodiment, one sensor could be installed for each of the keyboard's X and Y axes (2 sensors total). In yet another embodiment, a number of sensors could be installed for each of the X and Y axes near groups of keys. In this embodiment, the sensors detect movement left, right, up, or down on the entire keyboard or parts of the keyboard. In still another embodiment, each row and/or column could have one pair of sensors. In the case of a virtual keyboard, a touchscreen sensor can identify the entered characters by sensing a swipe movement (as opposed to just tap) on top of a key. For example, a user can contact the “P” key on a touchscreen keyboard and move his finger forward along the touchscreen (without lifting) to enter the letters “P” and “A”.

At least one embodiment of the invention defines character mapping that determines for each key the number of different directions to be tracked (e.g., along the X-Y plane) and the corresponding letter(s) that will be added when each direction is triggered. The character mapping also includes the minimum amount of pressure and/or duration of pressure (for physical keyboards) or distance swiped (for virtual keyboards) needed to trigger a direction. After each key tap/press, a keyboard driver can measure the X tilt and/or Y tilt in the key as the key is depressed. If the tilt is higher than a first constant for a specific direction, and/or the tilt lasts longer than a second constant, then the keyboard driver can simulate (insert) the character defined by the character mapping. In at least one embodiment, the only software change is in the keyboard driver, wherein the keyboard driver simulates the effect of the user pressing two keys when appropriate; and as such, all applications are compatible without the need to recode.

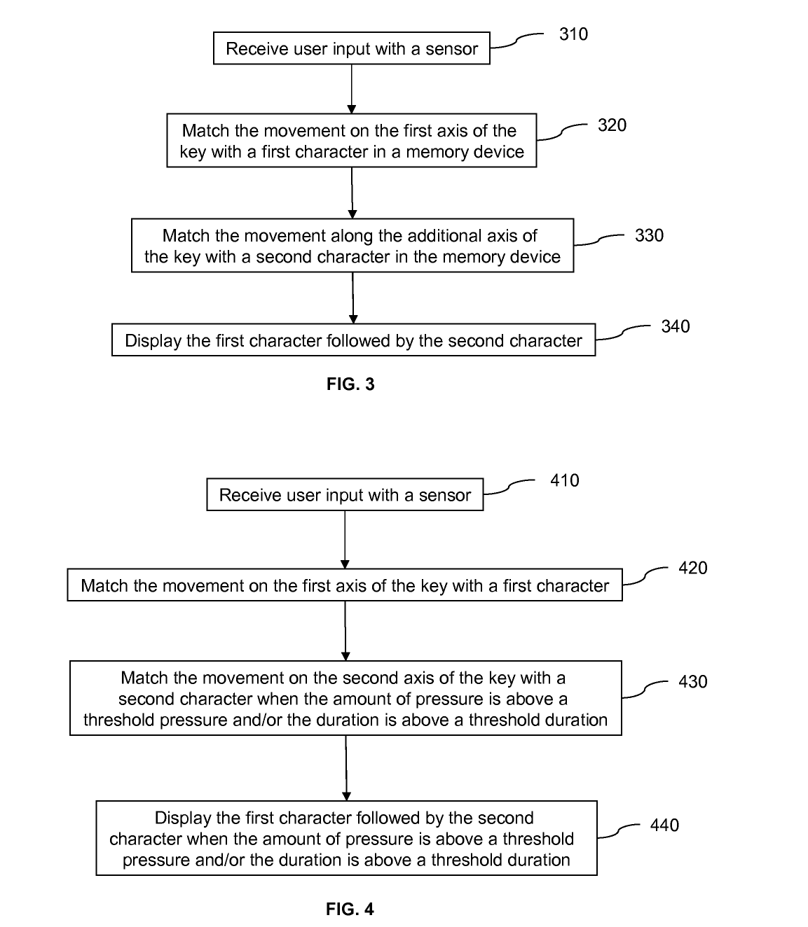

FIG. 3 is a flow diagram illustrating a method of character recognition according to an embodiment of the invention. As used herein, the term “character” includes letters, numbers, punctuation, symbols, and special characters (e.g., accents, umlauts). User input is received with a sensor proximate to and/or connected to a key of a keyboard 310. In at least one embodiment, the sensor is a hardware device connected to the key for determining the angle of input, wherein the sensor includes pressure-sensitive sensors (e.g., piezoelectric sensors) and/or optical sensors.

As used herein, the term “connected” includes operationally connected, logically connected, in communication with, physically connected, engaged, coupled, contacts, linked, affixed, and attached. Moreover, the term “keyboard” as used herein includes physical keyboards, such as QWERTY keyboards connected to a desktop computer or on a laptop computer; keypads, such as those connected to a telephone; and virtual keyboards, such as those on the touchscreen displays of some tablet computers and smartphones.

In at least one embodiment of the invention, the user input includes movement on a first axis of the key and movement on a second axis (also referred to herein as the “at least one additional axis”) of the key. For example, the movement on the first axis is a downward movement (generally perpendicular to the upper surface of the key and/or keyboard); and, the movement on the second axis is a movement forward, backward, to the left, and/or to the right of the center of the key. The embodiment illustrated in FIG. 1 shows five different examples of movement along a “second axis”, a forward direction and four different diagonal directions: forward and to the right, backward and to the right, backward and to the left, and forward and to the left. Thus, movement downward is along the Y axis; and, movement in the second axis can be movement along the X and/or Z axis.

In at least one embodiment of the invention, the key represents a consonant character on a keyboard, and the movement along at least one additional axis of the key represents a vowel character. In another embodiment, the key is on a touchscreen keyboard, wherein the user input is a contact movement on the key and a swipe movement over or from the key. For example, the user can touch a key with his finger and move his finger in a direction along the touchscreen without lifting his finger.

A processor matches the movement on the first axis of the key with a first character in a memory device 320, and matches the movement along at least one additional axis of the key with a second character in the memory device 330. In at least one embodiment, the processor is a hardware device connected to the sensor and the memory device. The memory device is a hardware storage device (e.g., RAM) that includes a plurality of characters, where each of the characters corresponds to a key on the keyboard and a movement on the key (e.g., downward movement on the first axis, forward movement on the second axis). For instance, in the example illustrated in FIG. 1, the memory device associates the letter “P” with a downward movement on the “P” key of a keyboard. Moreover, the memory device associates the letters “A”, “E”, “I”, “O”, “U” with forward, forward and right, backward and right, backward and left, and forward and left movements on the “P” key. Thus, the matching of the movement on the at least one additional axis (also referred to herein as the “second axis”) of the key with the second character includes querying a database of key movements, wherein each of the key movements corresponds to a character.

The processor is further connected to a display (e.g., touchscreen device, computer monitor, cell phone screen, e-reader screen), which displays the first character followed by the second character 340. Thus, the user input results in the display of two characters with the strike (actuation, contact, depression, swipe, movement) of one key.

FIG. 4 is a flow diagram illustrating a method of character recognition according to another embodiment of the invention. User input is received with a sensor proximate to and/or connected to a key of a keyboard 410, wherein the user input includes movement on a first axis of the key and movement on at least one additional axis (also referred to herein as the “second axis”) of the key. In at least one embodiment, the key is on a touchscreen keyboard, wherein the user input is a contact movement on the key and/or a swipe movement over the key. The sensor can determine the amount of pressure of the movement on the second axis of the key and/or the duration and/or distance of the movement on the second axis of the key. For example, the sensor can detect that the user input along the second axis was 0.05 pounds-per-square-inch (PSI) for 0.62 seconds with a swipe span of 30 pixels.

A processor matches the movement on the first axis of the key with a first character 420, and matches the movement on the second axis of the key with a second character 430. In at least one embodiment of the invention, the movement on the second axis of the key is matched with the second character only when the amount of pressure of the movement on the second axis of the key is above a threshold pressure (e.g., 0.09 PSI) and/or the duration of the movement on the second axis of the key is above a threshold duration (e.g., 0.50 seconds) and/or the distance of the movement (e.g. 25 pixels).

To match the movement on the second axis of the key with the second character, the processor can query a database of key movements, wherein each of the key movements correspond to a character. In at least one embodiment, the key represents a consonant character on a keyboard; and, the movement on the second axis of the key represents a vowel character.

The processor is further connected to a display (e.g., touchscreen device, computer monitor, cell phone screen, e-reader screen), which displays the first character followed by the second character 440. Thus, the user input can result in the display of two characters with the activation of one key. In at least one embodiment, the second character is only displayed when the amount of pressure of the movement on the second axis of the key is above the threshold pressure and/or the duration of the movement on the second axis of the key is above the threshold duration.

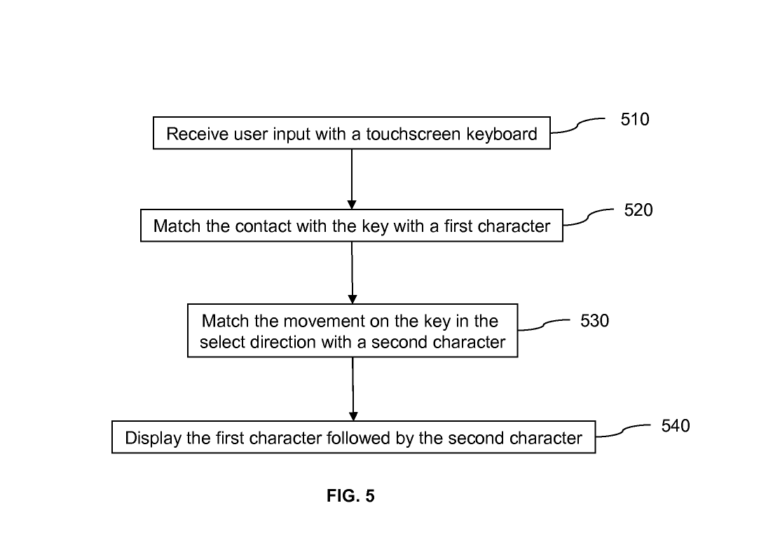

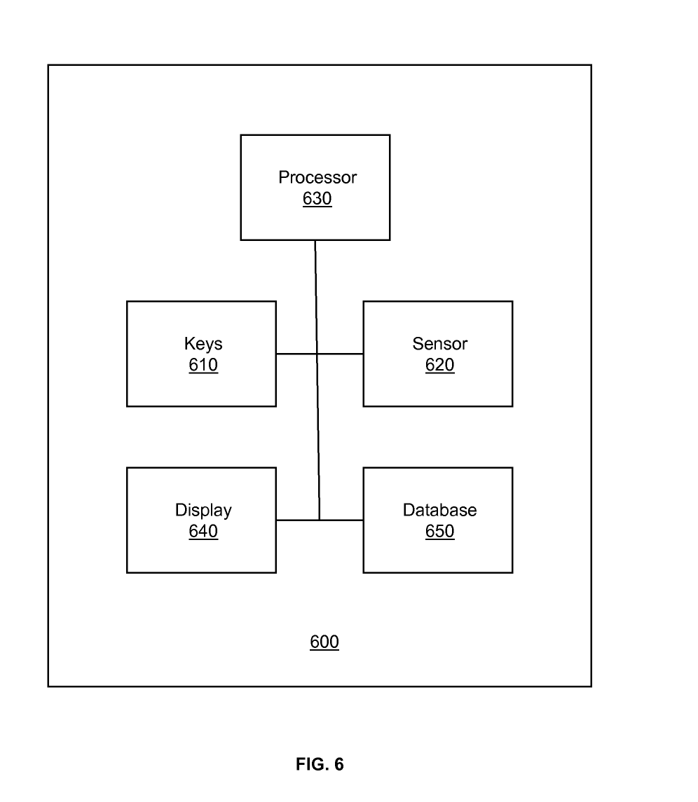

FIG. 5 is a flow diagram illustrating a method of character recognition according to another embodiment of the invention. User input is received with a touchscreen keyboard 510, wherein the user input includes contact with a key on the touchscreen keyboard and movement (e.g., a swipe over movement). A processor matches the contact with the key with a first character 520, and matches the movement on the key in the select direction with a second character 530.

In at least one embodiment of the invention, the processor queries a database of key movements, wherein each of the key movements correspond to a character. For instance, in the example illustrated in FIG. 1, the letters “A”, “E”, “I”, “O”, “U” correspond with forward, forward and right, backward and right, backward and left, and forward and left movements on the “P” key. In at least one embodiment, the key represents a consonant character on the touchscreen keyboard; and, the movement on the key in the select direction represents a vowel character.

The processor is further connected to a display, which displays the first character followed by the second character 540. Thus, the user input results in the display of two characters with contact of a single key.

FIG. 6 illustrates a character input device 600 according to an embodiment of the invention, the character input device 600 including a plurality of keys 610, sensors 620, a processor 630, and a display 640. One or more of the keys 610 are moveable along a first axis and at least one second axis. A key 610 can be depressible along the first axis and tiltable along the second axis. For example, the “J” key illustrated in FIG. 2 is depressible along the Y axis and tiltable along the X or Z axes.

In at least one embodiment, each key includes a cap 210 positioned over a sensor 220, wherein a controller 230 is positioned between the cap 210 and the sensor 220. Thus, in a closed position, the controller 230 is connected to both the cap 210 and the sensor 230 (FIG. 2 illustrates the key in an open position). The controller 230 (e.g., joystick) is moveable via the cap 210 along the X, Y, and Z axes. The sensor 220 detects the movement of the controller 230 and sends a signal indicating the direction (axis) of the movement to the processor.

One or more of the sensors 620 are proximate to the key 610, wherein the sensors can include pressure-sensitive sensor(s) and/or an optical sensor(s). The sensor 620 identifies movement of the key 610 along the first axis (e.g., a downward depression). Moreover, the sensor 620 measures the amount of pressure of the movement of the key 610 along the second axis (0.2 PSI) and/or the duration of the movement of the key along the second axis (e.g., 0.9 seconds).

The processor 630 is connected to the sensor 620, wherein the processor 630 matches the movement of the key along the first axis with a first character. For example, as illustrated in FIG. 2, the processor 630 can match downward movement of the “J” key along the Y axis with the character “J”. Furthermore, the processor 630 matches the movement of the key along the second axis with a second character when the amount of pressure of the movement of the key along the second axis is above a threshold pressure and/or when the duration of the movement of the key along the second axis is above a threshold duration.

For example, as illustrated in FIG. 1, the processor 630 can match a forward movement of the “P” key along the second axis with the character “A” when the amount of pressure of the forward movement of the key along the second axis is above 0.10 PSI. In another example, the processor 630 can match a forward and right movement of the “P” key along the second axis with the character “E” when the duration of the movement of the “P” key along the second axis is above 0.05 seconds. The character input device 600 can further include a database of key movements 650, wherein each of the key movements corresponds to a character. In at least one embodiment, each key 610 represents a consonant character, and the movement of the key 610 along the second axis represents a vowel character.

The display 640 is connected to the processor 630, the display 640 displays the first character followed by the second character when the amount of pressure of the movement of the key along the second axis is above a threshold pressure and/or when the duration of the movement of the key along the second axis is above a threshold duration.

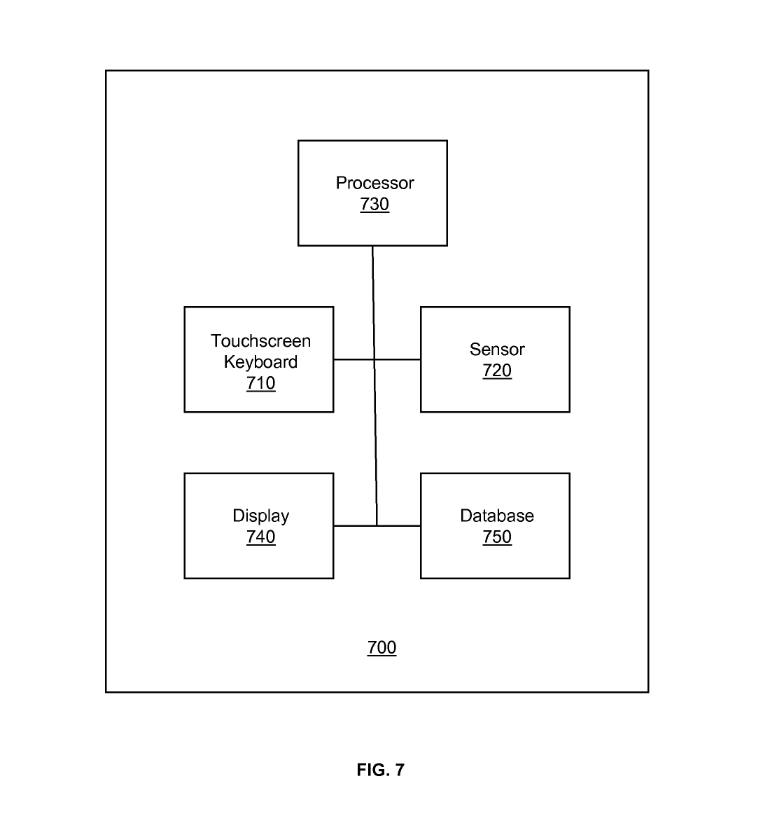

FIG. 7 illustrates a character input device 700 according to an embodiment of the invention, the character input device 700 including a touchscreen keyboard 710, one or more sensors 720, a processor 730, and a display 740. The sensor(s) 720 are proximate the touchscreen keyboard 710, wherein the sensor(s) 720 identify contact on a key on the touchscreen keyboard 710 and movement on the key in a select direction. For example, a sensor 720 can identify contact of the “B” key on the touchscreen keyboard 710 and movement backward and right (diagonally) on the “B” key. The sensor(s) 720 can include pressure-sensitive sensor(s) and/or an optical sensor(s).

The processor 730 is connected to the sensor(s) 720, wherein the processor 730 matches the contact on the key with a first character and the movement on the key in the select direction with a second character. For instance, in the example above, the processor 730 matches the contact of the “B” key on the touchscreen keyboard 710 with the character “B”, and the diagonal movement backward and right on the “B” key with the character “O”.

The display 740 is connected to the processor 730, wherein the display 740 displays the first character followed by the second character. The character input device 700 can also include a database of movements on the key 750, wherein each of the movements on the key corresponds to a character. In at least one embodiment, keys on the touchscreen keyboard 710 represent consonant characters, and movements on the keys in select directions represent vowel characters.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

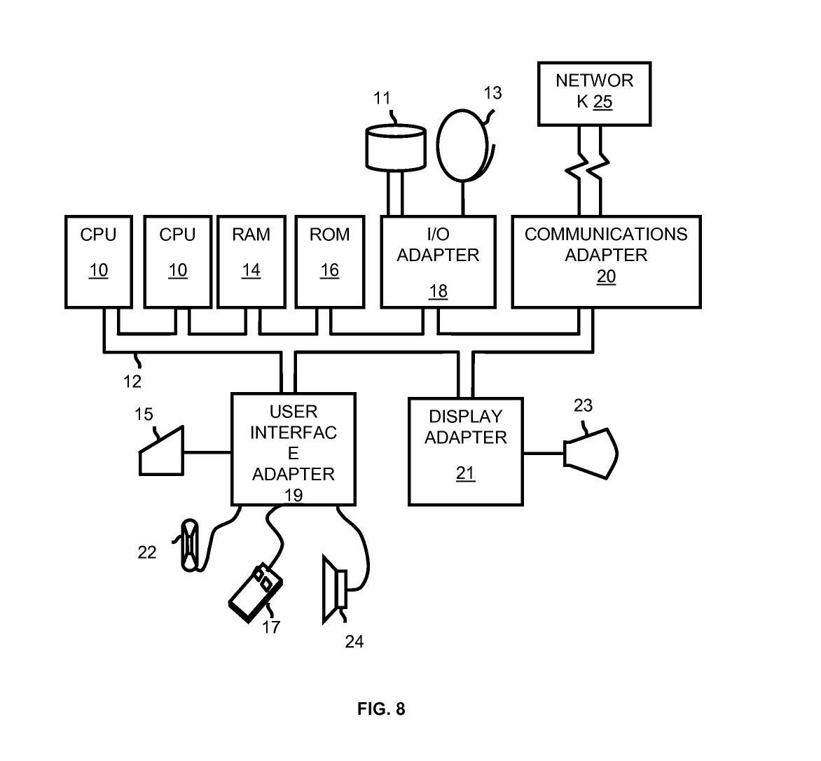

Referring now to FIG. 8, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device comprising:
a key moveable along a first axis and a second axis;
at least one sensor proximate said key, said sensor identifies at least one of movement of said key along the first axis and movement of said key along the second axis;
a processor connected to said sensor, said processor matches at least one of the movement of said key along the first axis with a first character and the movement of said key along the second axis with a second character; and
a display connected to said processor, said display displays the first character followed by the second character.

2. The device according to claim 1, further comprising a database of key movements, each of the key movements corresponding to a character.

3. The device according to claim 1, wherein said key represents a consonant character, and the movement of said key along the second axis represents a vowel character.

4. The device according to claim 1, wherein said key is depressible along the first axis and tiltable along the second axis.

5. The device according to claim 1, wherein said sensor includes at least one of a pressure-sensitive sensor and an optical sensor.

6. The device according to claim 1, wherein said sensor measures at least one of:
an amount of pressure of the movement of said key along the second axis; and
a duration of the movement of said key along the second axis.

7. A character input device comprising:
a key moveable along a first axis and a second axis;
at least one sensor proximate said key, said sensor identifies movement of said key along the first axis and measures at least one of:
an amount of pressure of movement of said key along the second axis, and
a duration of the movement of said key along the second axis;
a processor connected to said sensor, said processor matches:
the movement of said key along the first axis with a first character, and
the movement of said key along the second axis with a second character when at least one of
the amount of pressure of the movement of said key along the second axis is above a threshold pressure, and
the duration of the movement of said key along the second axis is above a threshold duration; and
a display connected to said processor, said display displays the first character followed by the second character when at least one of
the amount of pressure of the movement of said key along the second axis is above a threshold pressure, and
the duration of the movement of said key along the second axis is above a threshold duration.

8. The character input device according to claim 7, further comprising a database of key movements, each of the key movements corresponding to a character.

9. The character input device according to claim 7, wherein said key represents a consonant character, and the movement of said key along the second axis represents a vowel character.

10. The character input device according to claim 7, wherein said key is depressible along the first axis and tiltable along the second axis.

11. The character input device according to claim 7, wherein said sensor includes at least one of a pressure-sensitive sensor and an optical sensor.

12. A character input device comprising:
at least one sensor proximate a touchscreen keyboard, said sensor identifies contact on a key on said touchscreen keyboard and movement on said key in a select direction;
a processor connected to said sensor, said processor matches the contact on said key with a first character and the movement on said key in the select direction with a second character; and
a display connected to said processor, said display displays the first character followed by the second character.

13. The device according to claim 12, further comprising a database of movements on said key, each of the movements on said key corresponding to a character.

14. The device according to claim 12, wherein said key represents a consonant character, and the movement on said key in the select direction represents a vowel character.

15. The device according to claim 12, wherein said sensor includes at least one of a pressure-sensitive sensor and an optical sensor.

16. A computer program product for character recognition, said computer program product comprising:
a non-transitory computer readable storage medium;
first program instructions to receive user input, the user input including movement on a first axis of a key and movement on a second axis of the key;
second program instructions to match the movement on the first axis of the key with a first character;
third program instructions to match the movement on the second axis of the key with a second character; and
fourth program instructions to display the first character followed by the second character,
wherein said first program instructions, said second program instructions, said third program instructions, and said fourth program instructions are stored on said computer readable storage medium.

17. The computer program product according to claim 16, wherein said third program instructions query a database of key movements, each of the key movements corresponding to a character.

18. The computer program product according to claim 16, wherein the key represents a consonant character on a keyboard, and the movement on the second axis of the key represents a vowel character.

19. The computer program product according to claim 16, wherein the user input results in the display of two characters with the activation of one key.

20. The computer program product according to claim 16, wherein the key is on a touchscreen keyboard, the user input is at least one of a contact movement on the key and a swipe movement over the key.
